(19) United States
(12) Patent Application Publication
(10) Pub. No.: US 2026/0140705 A1
(43) Pub. Date: May 21, 2026

(54) Method and Device for Code Generation for Calculating a Neural Network with Recalibratable Parameters

(71) Applicant: Robert Bosch GmbH, Stuttgart (DE)

(72) Inventors: Markus Lochmann, Reutlingen (DE); Benjamin Wagner, Friedrichshafen (DE); Duy Khoi Vo, Waiblingen (DE); Leif Sulaiman, Lund (SE); Sebastian Boblest, Duernau (DE); Ulrik Hjort, Malmö (SE)

(21) Appl. No.: 19/388,117

(22) Filed: Nov. 13, 2025

(30) Foreign Application Priority Data
Nov. 15, 2024 (DE) 10 2024 211 009.4

(51) Int. Cl. G06F 8/30; G06F 8/41

(52) U.S. Cl. CPC G06F 8/30; G06F 8/41

(57) ABSTRACT

A computer-implemented method for performing a code generation for determining a recalibratable code for computing a neural network includes (i) providing a source code for implementing the neural network that does not contain the network parameters defining the neural network, i.e. their configuration and their parameterization, as constants, wherein the source code is configured to access a parameter dataset with predetermined network parameters, in which all parameters necessary for recalibration of the neural network are contained, (ii) compiling the source code so that a program code for the desired hardware environment is generated, (iii) providing the network parameters to be accessible by the program code, and (iv) implementing the generated program code in the hardware environment.

This application claims priority under 35 U.S.C. § 119 to application no. DE 10 2024 211 009.4, filed on Nov. 15, 2024 in Germany, the disclosure of which is incorporated herein by reference in its entirety.

The disclosure relates to code generation for executing a neural network with in particular the possibility of simple recalibration of the neural network parameters.

### BACKGROUND

Neural networks or comparable data-based functions are used in a wide range of applications. In the field of embedded systems, the application to sensor signals such as acceleration and speed data, radar signals, power consumption, etc., is widely used to predict a quantity derived therefrom. The neural network thereby represents a function f, which calculates the output values \vec{y} from the input values \vec{x}

$$\vec{y} = f ( \vec{x} )$$

How well the function f can approximate the actual output values depends on the architecture of the neural network, i.e. the hyperparameters, which specify the type, number and dimensions of the individual layers, as well as on the network parameters, which specify weighting values, bias values, quantization parameters, kernel values and the like for individual nodes (neurons).

While the architecture of a neural network is a conscious design decision, the network parameters—weighting values, bias values, and quantization parameters—are determined during training by an optimization process.

In many areas where embedded systems are used, the software developed must be adapted to different product variants. In the automotive sector, for example, a firmware for a control unit can be adapted to various vehicle variants.

Typically, this is done by retraining the neural network rather than recompiling the entire firmware, in order to adjust the network parameters with new values. While the specific architecture of a neural network remains unchanged in such applications after a development phase, for example in order to obtain a one-time approval for the entire system, it is desirable to be able to adjust the trained network parameters retrospectively.

Data-based models are often represented in the automotive sector by one-dimensional or multi-dimensional maps. The maps may be retrospectively adjusted to specific vehicle characteristics, such as a specific engine. If this is to be enabled with neural networks, one possibility is the use of a library that implements the individual layers of neural networks. The specific neural network can then be stored in the system as a flat buffer, for example, and replaced as needed.

The advantage of this approach is its high degree of flexibility: Neither the network parameters nor the specific architecture of the neural network (for network description) needs to be specified. Both may also be replaced after the firmware has been compiled. The disadvantage of such an approach is its low efficiency, as flash memory is reserved for the maximum size of the network description, even though in actual practice only much smaller neural networks are used. The same applies to the required size of the memory and also to the required processing time if the neural network is to run in a time-critical task.

In addition, the use of a library prevents, at least to a large extent, the optimized implementation of the neural network on the desired hardware environment. If the specific architecture of the neural network is known, specific layer configurations can often be implemented significantly more efficiently with a code generator.

It is the object of the present disclosure to provide a method for code generation for implementing a neural network with fixed architecture to implement it as optimally as possible in terms of run time and memory consumption in a hardware environment. Furthermore, if a parameter of the installed neural network is changed, it should be possible to modify it without changing the code or recompiling.

### SUMMARY

This object is achieved by the method for code generation according to the description set forth below as well as a corresponding device according to the description set forth below.

Further embodiments are specified in the description set forth below.

According to a first aspect, a computer-implemented method for performing a code generation for determining a recalibratable code for computing a neural network is provided, with the steps of:
providing a source code for implementing the neural network that does not contain the network parameters defining the neural network, i.e. their configuration and their parameterization, as constants, wherein the source code is configured to access a parameter dataset with predetermined network parameters, in which all parameters necessary for recalibration of the neural network are contained;
compiling the source code so that a program code for the desired hardware environment is generated;
providing the network parameters to be accessible by the program code;
implementing the generated program code in the hardware environment.

The above method provides for a source code for implementing the neural network that does not contain the network parameters defining the neural network, i.e. their configuration and their parameterization, as constants. For example, the network parameters may be stored in a file and read at run time of the program to be used for the predetermined architecture (defined via hyper-parameters). Alternatively, the network parameters can be stored in a flash memory or other data store, as is already done for characteristic maps.

Thus, the network parameters are not compiled as part of the source code, but rather the code is generated so that a variable parameterization of a neural network can be read in using a parameter dataset.

In this way, the trained parameters of the neural network are not part of the program code, which cannot be changed after compilation, but may be provided separately.

This allows a simple recalibratability of the parameter set of the network parameters by simple provision as a file or in a data store. For this purpose, reference can be made to the parameter set of the network parameters by way of a simple address pointer.

In order to make the generated code flexibly calibratable, various changes are necessary compared to ordinary code generation. The parameter set can receive a C-struct with pointers to the network parameters or another indication for the initialization of the pointers. How these pointers are initialized will depend on the specific implementation on the hardware environment of the target system.

For quantized networks, there are additional requirements for the method. Each layer in a quantized network has one or more scale parameters for the input vector, one or more scale parameters for the output vector, and one or more scale parameters for the weights, as for tensors in quantized layers in neural networks, it must also be specified which float32 value range corresponds to the quantized values of the respective tensor.

Each scale parameter s_{float32} is approximated by two integer values, a shift value s and a multiplier m. The connection is given by

$${s}_{float 32} \approx \frac{m \times {2}^{s}}{{2}^{31}} .$$

In conventional program code, shift value s and multiplier m may be implemented as constant values in the generated code. However, in the calibratable code, they need to be flexible as they depend on the network parameters being trained. Thus, the scale parameter must also be included as the parameter dataset in addition to the network parameters. They must then be passed as functional arguments to the layer functions (functions for calculating the layers of the neural network).

The same applies to the offset of the input and output data, which specifies where the zero point is within the quantized value range and the minimum and maximum values corresponding to the activation function used.

If shift s, multiplier m, and offsets of the input and output data are no longer set, the implementations of certain auxiliary functions in the generated code will also change.

For example, if the sign of shift s is specified at generation time in the Embedded AI Coder code generator, the code generator can use an optimized requantization function depending on whether shift s is positive or negative. Another point relates to layers with activation features such as RELU. RELU sets negative starting values to zero. In quantized networks, the zero point is therefore set to the respective minimum value of the quantization data type whenever possible. In the case of int8-quantized networks, this means −128. In these cases, the requantized values with an optimized function SSAT may be limited to the legal value range q∈[−128 . . . 127] if the target architecture provides such a function.

In contrast, in calibratable code, no assumptions can be made about the sign of the shifts s or the zero point of layers with the RELU activation function. The generated code must then use more general implementations for the requantization function and instead of SSAT.

If calibratable code is recalibrated with new network parameters, the code generator must ensure that the new parameter data matches the generated code. To ensure this, all topological characteristics of the network and all layers, as well as any code generator options for all code generations, must be stored. The necessary information is the topology or architecture of the neural network, i.e., complete information about which layers consume the output of which layers as input, the topological properties of each individual layer, e.g., the dimensions of the matrices in fully connected layers, the kernel sizes, dilation, padding, and stride for convolutions, the hyperparameters that are not trained, such as the a value of a LeakyRelu, and the code generator options that influence the generated code.

If a neural network is calibrated, this information must be compared to the original and be identical. Additionally, in each calibration step, code may be generated again and compared to the original, of course, without being recompiled.

### BRIEF DESCRIPTION OF THE DRAWINGS

Preferred embodiments are described in more detail below with reference to the accompanying drawings.

FIG. 1 a schematic illustration of a platform for code generation and implementation in a hardware environment;

FIG. 2 a schematic representation of a process flow for generating a recalibratable program code for performing the calculation of a neural network;

FIGS. 3a and 3b comparisons of two code implementations for a conventional code generator and a code generator for creating a recalibratable program code;

FIG. 4 a code example for the form of a C-struct for the parameters considered in the compilation of the source code.

### DETAILED DESCRIPTION

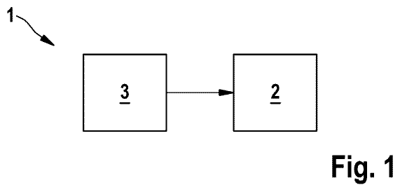

FIG. 1 shows a block diagram of a platform 1 for performing code generation and implementing a generated program code in a hardware environment 2. For example, the hardware environment corresponds to a control device having a microcontroller, microprocessor, or the like. Code generation is done on a conventional computer 3 or workstation based on the specified configuration of a neural network. The computer 3 is configured to perform code generation accordingly.

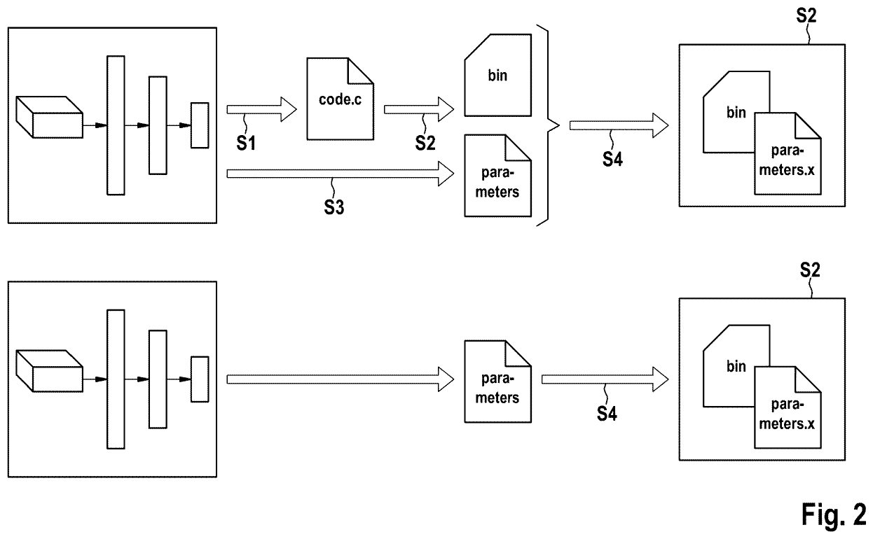

FIG. 2 schematically shows the process flow for code generation of a recalibratable program code for implementing a neural network NN1, NN2. To this end, in step S1, the code generator provides for creating a source code code.c, e.g., in C or Rust or another target programming language, which accesses a parameter dataset with specified network parameters, containing all parameters required for recalibrating the neural network.

The source code is compiled in step S2 so that the generated program code bin can be implemented for the desired hardware environment.

In step S3, the network parameters are provided. This may be done as a binary file, such as “parameters.x”, or in more specific file formats, such as DCM files, that are often used in the automotive sector.

For example, they may be encapsulated as C-struct or provided in other encapsulated form to the compiled network.

The generated program code “bin” is then implemented in step S4 in the hardware environment and can access the provided network parameters.

If the neural network is to be recalibrated (NN2), a further parameter set parameters' may be provided, which is then implemented in hardware environment 2. In certain use cases, multiple different parameter sets may also be stored in the file system and exchanged flexibly.

The hardware environment then has access to the parameter dataset, which may be stored, for example, in a parameter file or in a storage area of an available data store. If the network is to be recalibrated, it is only necessary to change the parameter dataset and make it available in the hardware environment. When the program code is executed, it will then access the updated parameter dataset and can thus perform the recalibrated function.

Additionally, the parameter dataset may contain information that affects the code generated and may depend on the configuration of the recalibrated neural network.

In addition to the network parameters, each layer in a quantized network has one or more scale parameters for the input vector, one or more scale parameters for the output vector, and one or more scale parameters for the weights, as for tensors in quantized layers in neural networks, it must also be specified which float32 value range corresponds to the quantized values of the respective tensor.

Each scale parameter S_{float32} is approximated by two integer values, a shift value s and a multiplier m. The connection is given by

$${s}_{float 32} \approx \frac{m \times {2}^{s}}{{2}^{31}} .$$

In the calibratable code, shift value s and multiplicator m need to be flexible as they depend on the network parameters being trained. This means that the parameter data set must provide the scale parameter in addition to the network parameters. They must then be passed as functional arguments to the layer functions (functions for calculating the layers of the neural network).

The same applies to the offset of the input and output data, which specifies where the zero point is within the quantized value range and the minimum and maximum values corresponding to the activation function used.

If shift S, multiplier m, and offset of the input and output data are no longer set, the implementations of certain auxiliary functions in the generated code will also change.

For example, if the sign of shift s is specified at generation time in the Embedded AI Coder code generator, the code generator can use an optimized requantization function depending on whether shift s is positive or negative. Another point relates to layers with activation features such as RELU. RELU sets negative starting values to zero. In quantized networks, the zero point is therefore set to the respective minimum value of the quantization data type whenever possible. In the case of int8-quantized networks, this means −128. In these cases, the requantized values with an optimized function SSAT may be limited to the legal value range q∈[−128 . . . 127] if the target architecture provides such a function.

In calibratable code, the offsets are variable and a more general function must be used.

The requantization function requant(q, multiplier, shift) may be optimized with a known sign of shift.

For example, the optimization may be illustrated using the corresponding CMSIS NN function arm_nn_requantize. This uses two function1 and function2 auxiliary functions, whose operation is irrelevant here:

| | |
|---|---|
| 1 | int32_t arm_nn_requantize(const int32_t val, |
| 2 | const int32_t multiplier, |
| 3 | const int32_t shift) |
| 4 | { |
| 5 | const int32_t temp = val * (1 << LEFT_SHIFT(shift)); |
| 6 | const int32_t dividend = function1(temp, multiplier); |
| 7 | const int32_t exponent = RIGHT_SHIFT(shift); |
| 8 | |
| 9 | return function2(dividend, exponent); |
| 10 | } |

The included macros LEFT_SHIFT and RIGHT_SHIFT are defined as
#define LEFT_SHIFT(shift)(shift>0? shift: 0)
#define RIGHT_SHIFT(shift)(shift>0 ? 0: −shift)
Obviously, shift>0
LEFT_SHIFT (shift)=shift
RIGHT_SHIFT (shift)=0
and for shift<=0
LEFT_SHIFT (shift)=0
RIGHT_SHIFT (shift)=−shift

The potential for optimization of two separate implementations for positive and negative shifts is apparent.

Additionally, if shift<=0, the sign of shift can be inverted at code generation time to avoid having to perform the inversion at run time. The positive shift then results in:

| | |
|---|---|
| 1 | int32_t requantize_negative_shift(const int32_t val, |
| 2 | const int32_t multiplier, |
| 3 | const int32_t shift) |
| 4 | { |
| 5 | const int32_t dividend = function1(val, multiplier); |
| 6 | |
| 7 | return function2(dividend, shift); |
| 8 | } |

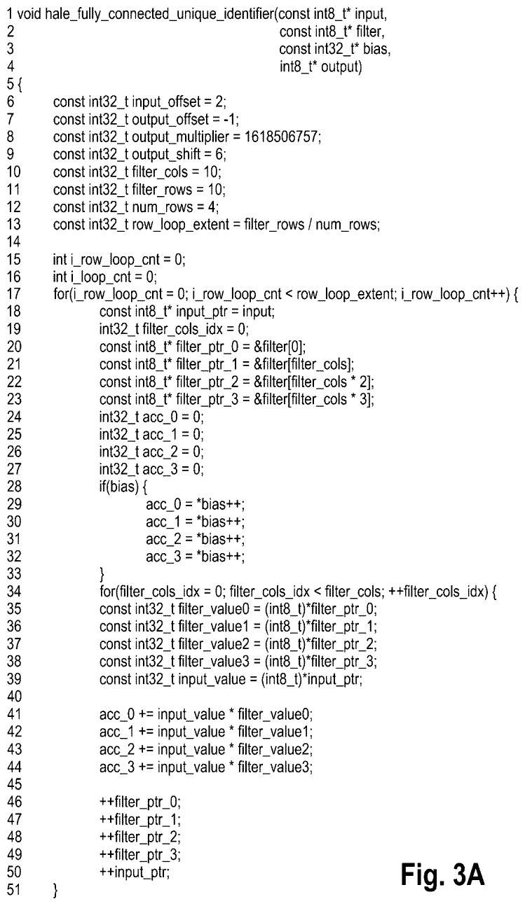

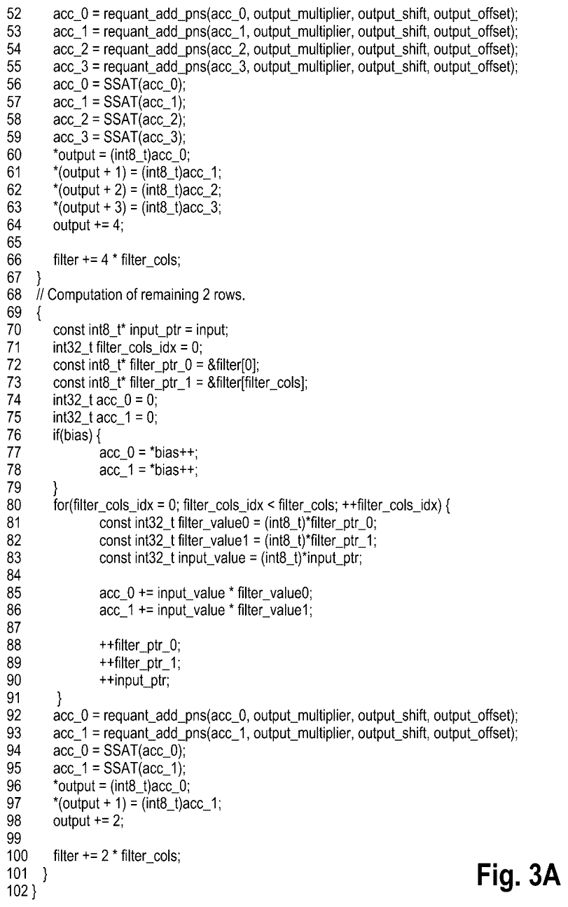

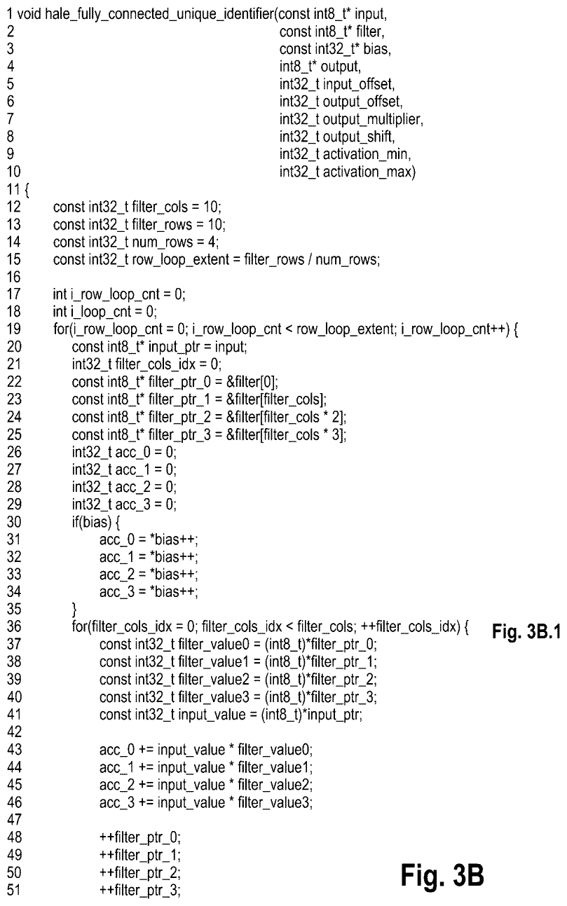

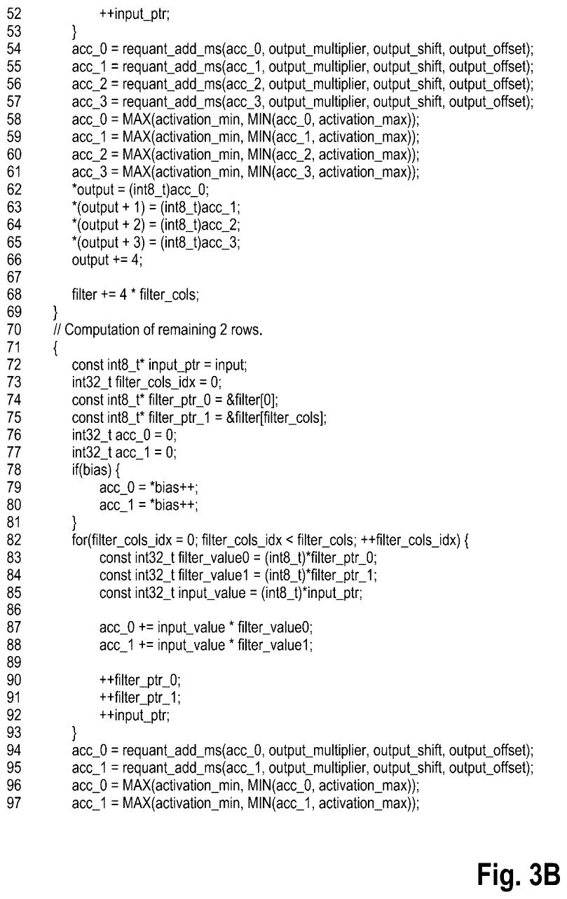

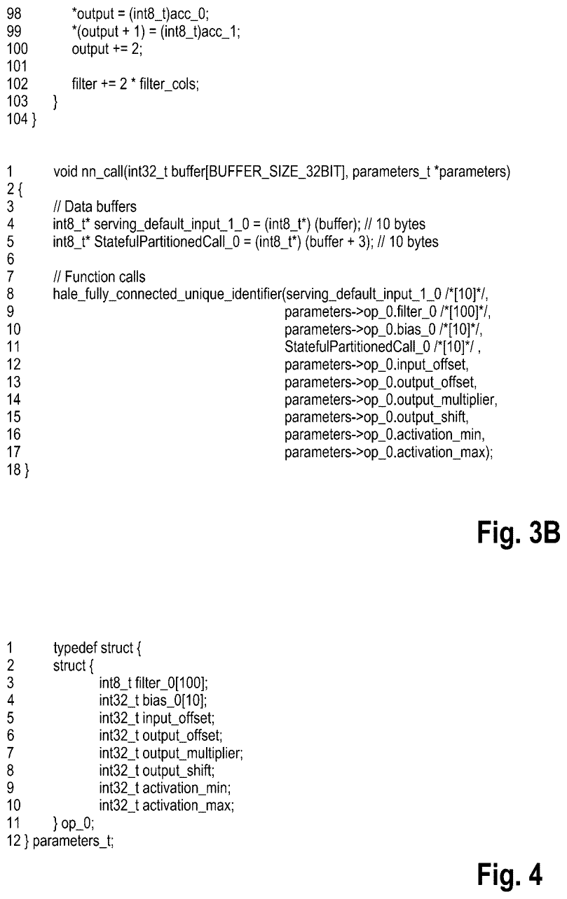

On certain hardware architectures, there is still further optimization potential with a known negative sign of shift. These additional optimizations are implemented in the requant_add_pns function used in FIG. 3a. If shift>=0 is known, the result is instead:

| | |
|---|---|
| 1 | int32_t requantize_positive_shift(const int32_t val, |
| 2 | const int32_t multiplier, |
| 3 | const int32_t shift) |
| 4 | { |
| 5 | const int32_t temp = val * (1 << shift); |
| 6 | const int32_t dividend = function1(temp, multiplier); |
| 7 | |
| 8 | return function2(dividend, 0); |
| 9 | } |

On certain hardware architectures, there is still further optimization potential with a known positive sign of shift. These additional optimizations are implemented in the requant_add_ps function not shown.

Due to the additional optimizations, the functions requant_add_ms in FIG. 3b, requant_add_pns in FIG. 3a, and the function requant_add_ps (not shown) have output_offset as an additional function argument.

In most cases, activations in quantized layers are constrained to the range of values q∈[−128, 127]. This must already be determined by the quantization algorithm. In rare cases, however, other ranges of values may result depending on parameters, such as q∈[−128, 124]. The standard case q∈[−128, 127] may be implemented on certain hardware architectures with specific instructions:

$$q = S S A T ( q ) ;$$

In non-parameterizable code, this function SSAT can be used. In parameterizable code, the use of

$$q = MAX ( q\_min , MIN ( q , q\_max ) ) ;$$

is required. The values q_min and q_max must be encoded as functional arguments, since they can change during reparametrization.

In contrast, optimizations that adapt the generated code to the fixed topology of the neural network are also possible in parameterizable code.

Examples of such optimizations are the adjustment to the exact dimensions of the matrix of a FullyConnected layer and the adjustment to the kernel size, the stride, the dilation and the padding in convolutions. These optimizations can additionally also be adapted to the respective target hardware.

For this reason, significantly better performance is possible with the generated parameterizable code than with a library implementation.

Both points, where parameterizable code must use a more general, less efficient implementation, become clear when comparing the generated non-parameterizable code in FIG. 3a and the parameterizable code for the same fully connected layer in FIG. 3b.

Other examples of this, which can also occur in non-quantized models, i.e., those that work with float values and therefore do not use shifts and multipliers, are if-else conditions that depend on the parameters, such as in LSTM networks. In non-parametrizable code, such conditions may be resolved at the code generation time and only the relevant branch is generated as code. This is not possible in parameterizable code.

If calibratable code is recalibrated with new network parameters, the code generator must ensure that the new parameter data matches the generated code. To ensure this, all topological characteristics of the network and all layers, as well as any code generator options for all code generations, must be stored. The necessary information is the topology or architecture of the neural network, i.e., complete information about which layers consume the output of which layers as input, the topological properties of each individual layer, e.g., the dimensions of the matrices in fully connected layers, the kernel sizes, dilation, padding, and stride for convolutions, the hyperparameters that are not trained, such as the a value of a LeakyRelu, and the code generator options that influence the generated code.

If a neural network is calibrated, this information must be compared to the original and be identical. Additionally, in each calibration step, code may be generated again and compared to the original, of course, without being recompiled.

FIGS. 3a and 3b show a comparison in the form of code examples of a fully connected layer implementation by a conventional code generator and a code generator with recalibratable configuration and parameterization of the neural network.

Lines 1-11 of the code of FIG. 3a and lines 1-10 of the code of FIG. 3b: The calibratable function also accepts all integer parameters that can change during calibration as arguments. The conventional function defines these as constants.

Lines 12-13 of the code of FIG. 3a and lines 14-15 of the code of FIG. 3b: Both implementations calculate four rows of the matrix in parallel in order to have to load the input data less often. This is an optimization in code generation and is adapted to the specific layer of the neural network and to the hardware environment. As the shift topology does not change, the calibratable code may also use this optimization.

Lines 52-59 of the code of FIG. 3a and lines 54-61 of the code of FIG. 3b: For requantization, the conventional code of FIG. 3a uses the requant_add_pns function. This is only usable if the shift value is negative. The code generation then reverses the sign. The calibratable code here must use the less optimized function requant_add_ms, which does not require any assumptions about the shift.

Analogously, the optimized code may use the optimized function SSAT to restrict the data to the int8 value range. Since activation_min and activation_max cannot be assumed to be known in the calibratable code, instead of using SSAT, it must use MIN and MAX to restrict the requantized values to the permissible value range.

From line 68 of the code of FIG. 3a and from line 70 of the code of FIG. 3b: In the calculation of four lines in parallel, two lines remain, which are calculated separately.

FIG. 4 shows a code example for the encapsulated form of a C-struct that is considered when compiling the source code.

What is claimed is:

1. A computer-implemented method for performing a code generation for determining a recalibratable code for computing a neural network, comprising:
providing a source code for implementing the neural network that does not contain the network parameters defining the neural network including their configuration and their parameterization, as constants, wherein the source code is configured to access a parameter dataset with predetermined network parameters, in which all parameters necessary for recalibration of the neural network are contained;
compiling the source code so that a program code for the desired hardware environment is generated;
providing the network parameters to be accessible by the program code; and
implementing the generated program code in the hardware environment.

2. The method according to claim 1, wherein the network parameters are stored in a file or data store and are readable at run time of the program code and provided in encapsulated form.

3. The method according to claim 1, wherein for quantized networks, in addition to the network parameters, one or more scale parameters are further provided for the input vectors, the output vectors, and the network parameters of each layer, which specify the relationship between the quantized value range and the original float32 value range.

4. A device for performing the method according to claim 1.

5. A computer program product comprising instructions which, when the program is executed by at least one data processing device, cause the data processing device to perform the steps of the method according to claim 1.

6. A machine-readable storage medium comprising commands which, when executed by at least one data processing device, cause the data processing device to perform the steps of the method according to claim 1.

7. A computer-implemented method for performing a code generation for determining a recalibratable code for computing a neural network, comprising:
providing a source code for implementing the neural network that does not contain the network parameters defining the neural network as constants, wherein the source code is configured to access a parameter dataset with predetermined network parameters, in which all parameters necessary for recalibration of the neural network are contained;
compiling the source code so that a program code for the desired hardware environment is generated;
providing the network parameters to be accessible by the program code; and
implementing the generated program code in the hardware environment.

8. The method according to claim 1, wherein the network parameters are stored in a file or data store and are readable at run time of the program code and provided in encapsulated form as C-struct.
